(19) United States
(12) Patent Application Publication
(10) Pub. No.: US 2025/0286423 A1
(43) Pub. Date: Sep. 11, 2025

(54) STATOR FOR A THREE-PHASE ELECTRIC MOTOR AND ASSOCIATED ELECTRIC MOTOR

(71) Applicant: VALEO SYSTÈMES D'ESSUYAGE, Le Mesnil Saint Denis (FR)

(72) Inventors: Jose Luis Herrada, Le Mesnil Saint Denis (FR); Mehdi Belhaj, Le Mesnil Saint Denis (FR)

(73) Assignee: VALEO SYSTÈMES D'ESSUYAGE, Le Mesnil Saint Denis (FR)

(21) Appl. No.: 18/697,279

(22) PCT Filed: Sep. 30, 2022
(86) PCT No.: PCT/EP2022/077333

§ 371 Date: Sep. 4, 2024

(30) Foreign Application Priority Data
Sep. 30, 2021 (FR) 2110382

(51) Int. Cl. H02K 3/28

(52) U.S. Cl. CPC H02K 3/28

(57) ABSTRACT

The present invention relates to a stator (1) for a three-phase electric motor, comprising:
a plurality of coils (5) distributed circularly on a stator body (3),
a set of connection frames (10) arranged on various layers (c1, c2, c3, c4, c5) superposed axially and electrically insulated from one another, said connection frames (10) being configured to ensure the connections between the coils (5) of the various phases according to a predetermined electrical diagram and to ensure the power supply of the various phases via three power supply terminals (12u, 12v, 12w) associated with the respective phases,
   wherein the direction of power supply of one of the phases is reversed relative to the other two phases to limit the angular distance between the power supply terminals (12u, 12v, 12w) associated with the power supplies of the various phases.

The present invention relates to the field of three-phase electric motors, and in particular to three-phase electric motors intended to equip electric bicycles. Electric bicycles are becoming increasingly popular owing to the ease of travel they afford, while having low energy consumption, a low environmental impact, and a low cost price.

However, the use of an electric motor in an electric bicycle involves a number of constraints. In particular, it is necessary to provide a significant torque while limiting the weight and bulk of the electric motor as much as possible.

In order to limit the bulk, it is necessary to limit both the outer diameter of the stator and its axial length. To limit the diameter of the stator, it is known practice to arrange the connection frames ensuring the connections between the stator coils arranged circularly at the center of the circle formed by the coils. However, the connection frames must be electrically insulated from one another, which tends to increase the axial length of the stator.

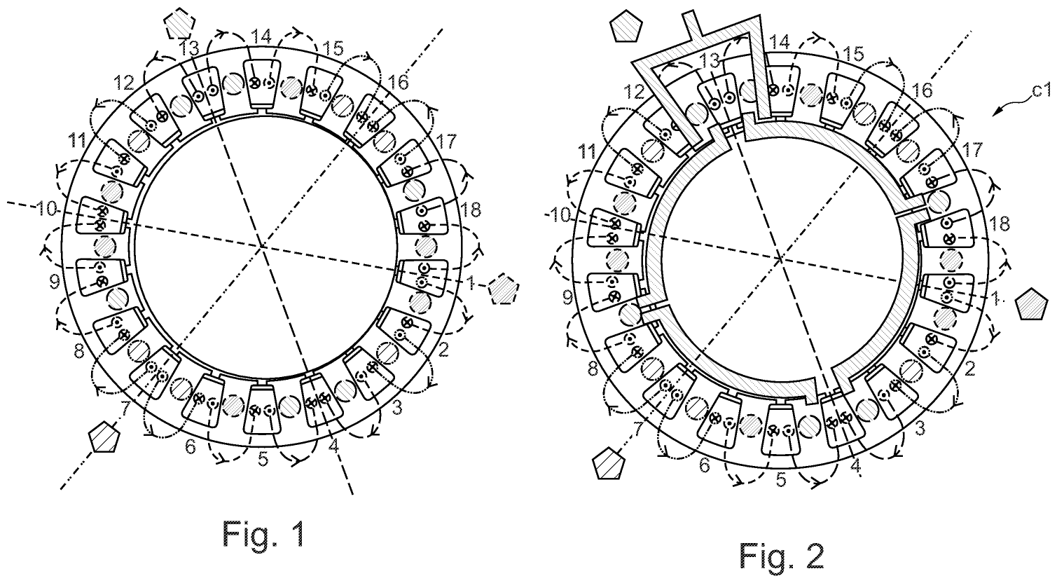

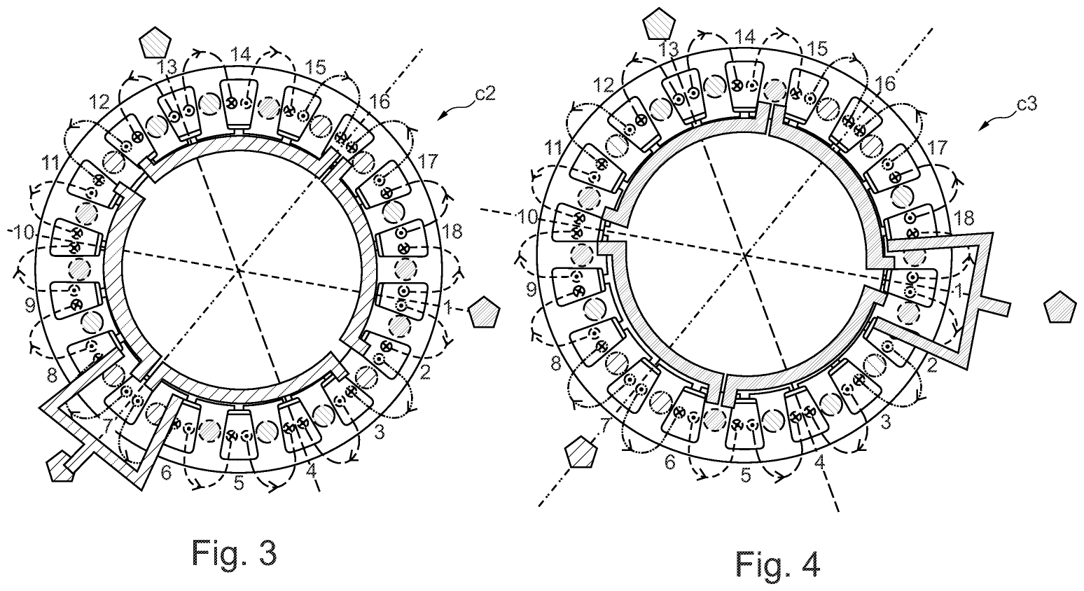

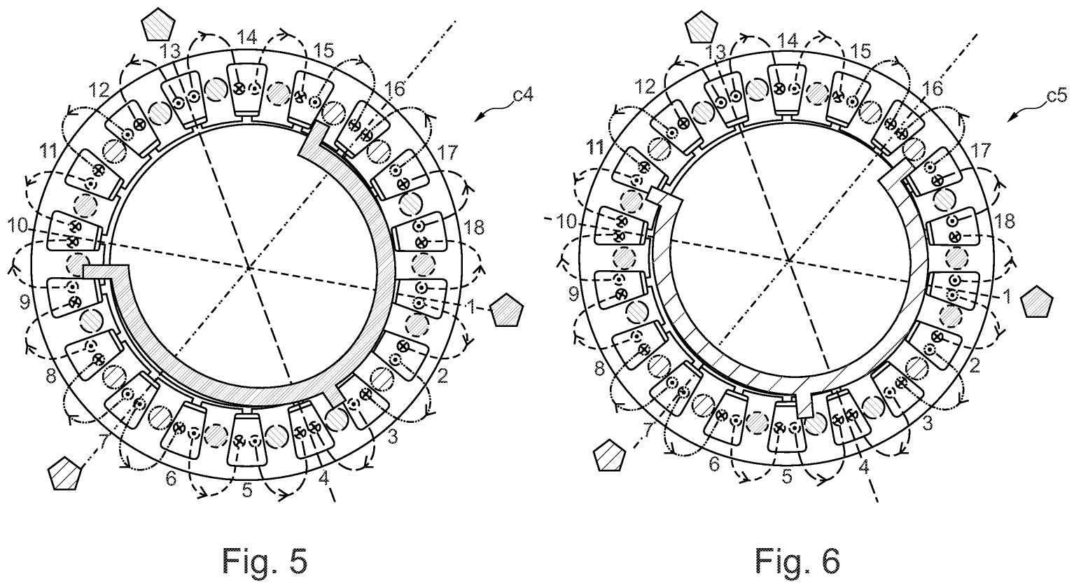

Moreover, the power supply of the phases u, v, w of the stator is generally implemented by power supply terminals or input terminals or positive terminals (intended to be connected to a positive terminal of a power source) associated with the various phases. However, owing to the arrangement of the coils, these power supply terminals are generally distanced from one another, the coils to be supplied with power of each of the phases being arranged at 120° from one another as shown in FIG. 1, in which the power supply terminals of each phase are indicated by hexagons and the coils by disks. Output terminals or negative terminals (intended to be connected to a negative terminal of a power source or to ground) are arranged diametrically opposite the power supply terminals or input terminals of the respective phases. FIGS. 2 to 6 show the various layers c1, c2, c3, c4, c5 of connection frames for making the various connections between the coils to obtain a three-phase star configuration in the case of a stator with 18 coils (6 coils per phase). Layer c1 in FIG. 2 ensures the connections of the coils of the first phase. Layer c2 in FIG. 3 ensures the connections of the coils of the second phase. Layer c3 in FIG. 4 ensures the connections of the coils of the third phase. The layers in FIGS. 5 and 6 ensure the connections between the phases to obtain the star configuration. Thus, in order to reduce the bulk and bring the power supply terminals closer to one another, it is necessary to reduce this angular distance between the various power supply terminals associated with the various phases without adding extra thickness in the axial direction to limit the length of the stator, or external cables which would increase the diameter of the stator.

It is therefore necessary to provide a solution allowing the power supply terminals to be brought closer to one another without increasing the dimensions of the stator. To this end, the subject matter of the invention is therefore a stator for a three-phase electric motor, comprising:
a plurality of coils distributed circularly on a stator body,
a set of connection frames arranged on various layers superposed axially and electrically insulated from one another, said connection frames being configured to ensure the connections between the coils of the various phases according to a predetermined electrical diagram and to ensure the power supply of the various phases via three power supply terminals associated with the respective phases, wherein the direction of power supply of one of the phases is reversed (that is, the positions of the power supply and output terminals of that phase are reversed) relative to the other two phases to limit the angular distance between the power supply terminals associated with the power supplies of the various phases. Reversing the direction of power supply of one of the phases makes it possible to place the three power supply terminals within an angular interval of 120° and thus reduce the angular spacing between the various power supply terminals compared to the prior art (angular interval of 360°).

According to another aspect of the present invention, the connection frames associated with the power supply terminals allowing the power supply of the various phases are arranged on one and the same layer of connection frames.

According to another aspect of the present invention, the connection frames associated with the power supply of the other two phases extend toward the connection frame associated with the power supply of the phase having the power supply which is reversed to receive the associated power supply terminal in order to reduce the angular distance between the power supply terminals associated with the power supply of the various phases.

According to another aspect of the present invention, at least one of the layers of connection frames is used to achieve:
connections between the coils of various phases, and/or
connections between the coils of one phase and the power supply of one or more phases.

According to another aspect of the present invention, the predetermined electrical diagram is a star or Delta configuration.

According to another aspect of the present invention, the stator comprises eighteen coils, each phase comprising a first and a second branch of three coils connected in series and wherein the connection frames are distributed over five layers. Other configurations, for example with twelve coils, are also possible.

According to another aspect of the present invention, a first and a second layer of connection frames respectively comprise the connection frames associated with the connections of the coils of a first and a second phase, a third layer of connection frames comprises the connection frames associated with a first portion of the connections of the coils associated with the third phase, a fourth layer comprises the connection frames for power supply of the phases and a connection frame for paralleling the three first branches associated with the three phases and a fifth layer comprises the connection frames associated with the second portion of the connections of the coils of the third phase and a connection frame for paralleling the three second branches associated with the three phases.

According to another aspect of the present invention, the reversal of the direction of power supply of a phase is obtained by reversing the connections between the inputs and the outputs associated with the phase, that is to say the power supply terminal or input terminal or positive terminal (intended to be connected to a positive terminal of a power source) and the output terminal or negative terminal (intended to be connected to a negative terminal of a power source or to ground).

According to another aspect of the present invention, the reversal of the direction of power supply of a phase is obtained by reversing the direction of winding of the phase.

The present invention also relates to an electric motor comprising a stator as described above.

Further features and advantages of the invention will become more clearly apparent from reading the following description, which is given by way of illustrative and non-limiting example, and the appended drawings, in which:

FIG. 1 shows a schematic view of a stator and the associated connections for ensuring the power supply of the coils according to one embodiment of the prior art;

FIG. 2 shows a schematic view of a first layer of connection frames associated with the connections of the coils of a first phase, and a power supply terminal allowing the power supply of the first phase according to one embodiment of the prior art;

FIG. 3 shows a schematic view of a second layer of connection frames associated with the connections of the coils of a second phase, and a power supply terminal allowing the power supply of the second phase according to one embodiment of the prior art;

FIG. 4 shows a schematic view of a third layer of connection frames associated with the connections of the coils of a third phase, and a power supply terminal allowing the power supply of the third phase according to one embodiment of the prior art;

FIG. 5 shows a schematic view of a fourth layer of connection frames associated with a first portion of the connections between the coils of the various phases for obtaining a star configuration according to one embodiment of the prior art;

FIG. 6 shows a schematic view of a fifth layer of connection frames associated with a second portion of the connections between the coils of the various phases for obtaining a star configuration according to one embodiment of the prior art;

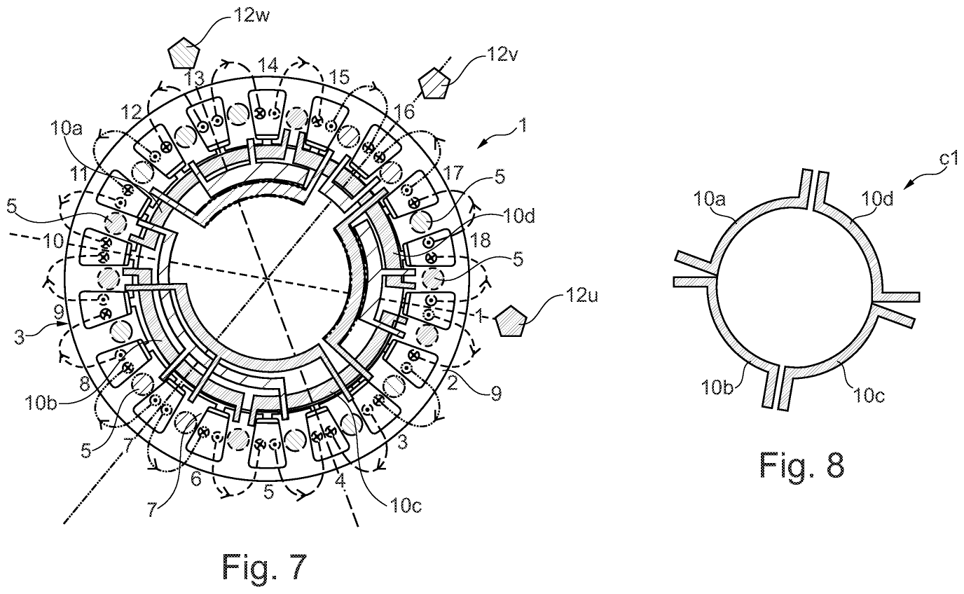

FIG. 7 shows a schematic view of a stator according to one embodiment of the present invention comprising certain layers of connection frames;

FIG. 8 shows a first layer of connection frames associated with the connections of the coils of a first phase;

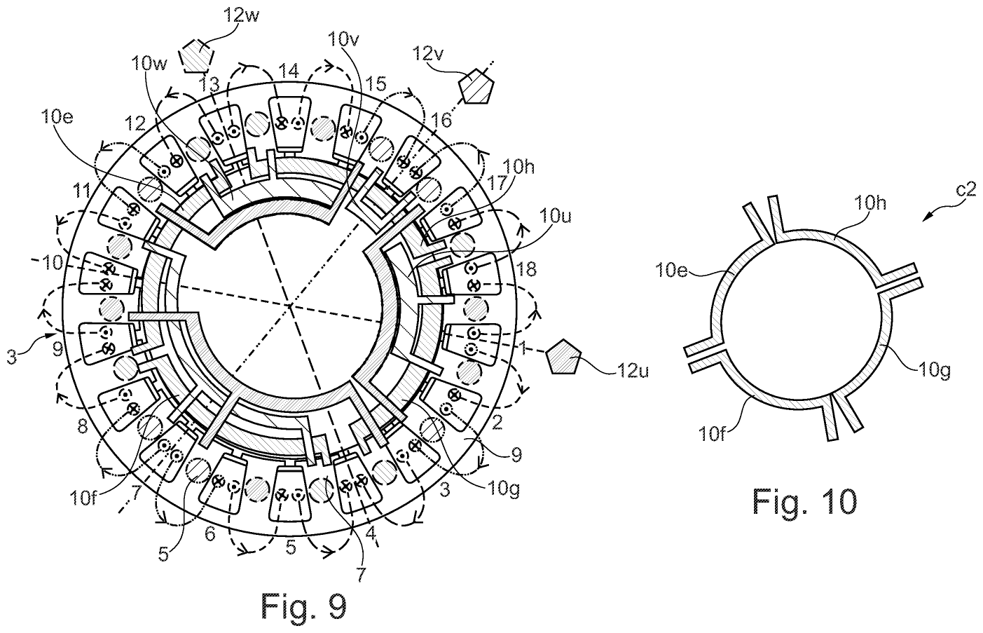

FIG. 9 shows a schematic view of a stator according to one embodiment of the present invention comprising certain layers of connection frames;

FIG. 10 shows a second layer of connection frames associated with the connections of the coils of a second phase;

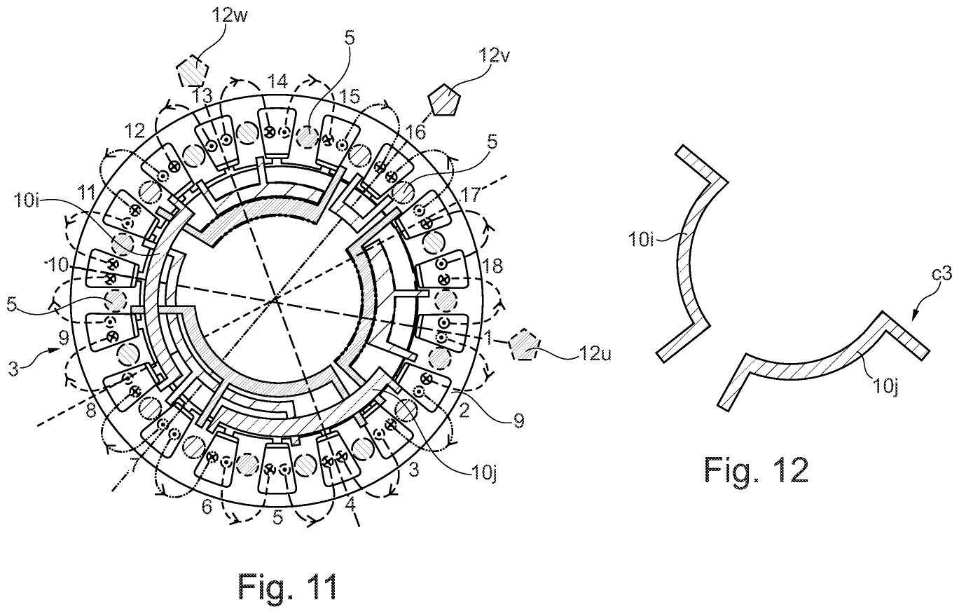

FIG. 11 shows a schematic view of a stator according to one embodiment of the present invention comprising certain layers of connection frames;

FIG. 12 shows a third layer of connection frames associated with a portion of the connections of the coils of a third phase;

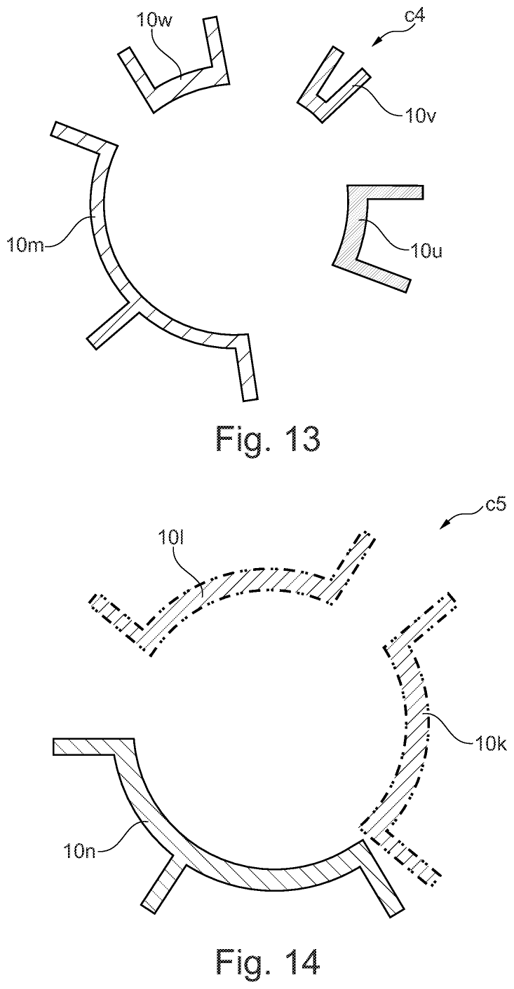

FIG. 13 shows a fourth layer of connection frames associated with the power supply of the phases via power supply terminals and with a first portion of the connections between the coils of the various phases for obtaining a star configuration;

FIG. 14 shows a fifth layer of connection frames associated with a second portion of the connections between the coils of the various phases for obtaining a star configuration and with a second portion of the connections of the coils of the third phase;

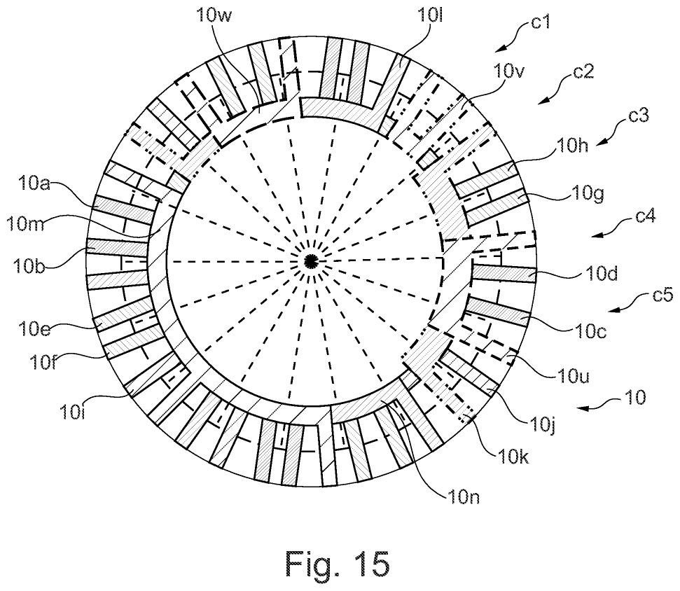

FIG. 15 shows a superposition of the various layers of connection frames according to one embodiment of the present invention;

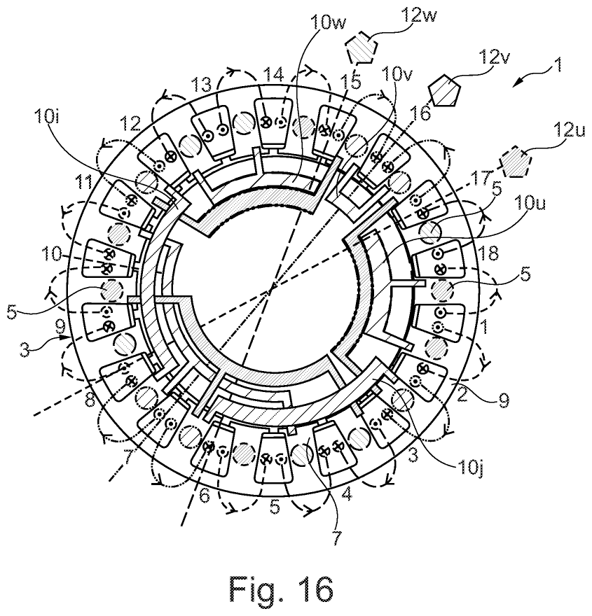

FIG. 16 shows a schematic view of a stator according to another embodiment of the present invention comprising certain layers of connection frames.

In these figures, identical elements have the same reference signs.

The following embodiments are examples. Although the description refers to one or more embodiments, this does not necessarily mean that each reference relates to the same embodiment, or that the features apply only to a single embodiment. Individual features of various embodiments may also be combined or interchanged to create other embodiments.

In the present description, some elements or parameters may be given ordinal numbers such as, for example, first element or second element and first parameter and second parameter, or first criterion and second criterion, etc. In this case, the purpose of the ordinal numbering is simply to differentiate between and denote elements or parameters or criteria that are similar but not identical. This ordinal numbering does not imply any priority being given to one element, parameter or criterion over another and such designations may be interchanged easily without departing from the scope of the present description. Likewise, this ordinal numbering does not imply any chronological order, for example in evaluating any given criterion. With regard to the reference numbers, a reference composed of a number and a letter, for example 10a, designates a particular element, in this case a particular connection frame, of a generic class of elements corresponding to the number; in this case, the reference 10 designates the set of connection frames 10a, 10b, etc.

The present invention relates to a stator 1 for a three-phase electric motor. The electric motor comprises a plurality of coils 5 arranged on a stator body 3. In the remainder of the description, the stator 1 comprises eighteen coils 5, or six coils 5 per phase. The phases are in a star configuration, each phase comprises a first and a second branch of three coils connected in series. However, a different number of coils 5 or a different configuration, for example a Delta configuration, may also be used. The stator body 3 comprises a plurality of teeth 7 made for example as a single piece with a yoke 9 as shown in FIG. 7, but other configurations, for example with separate teeth 7, may also be used without departing from the scope of the present invention. The coils 5, shown schematically by disks in FIG. 7, are formed by winding turns of a winding wire around the teeth 7. The teeth 7, and therefore the coils 5, are distributed circularly on the stator body 3. The coils 5 are arranged in such a way as to limit the number of connections between non-adjacent coils 5. The electrical connections between non-adjacent coils 5 are made by connection frames 10 arranged in the center of the coils 5. Thus, the stator 1 comprises a set of connection frames 10 arranged on different layers superposed axially and electrically insulated from one another. The connection frames 10 are configured to ensure the connections between the coils 5 of the various phases according to a predetermined electrical diagram, in this case a star configuration, but other configurations, for example a Delta configuration, are also possible. The connection frames 10 are also configured to ensure the power supply of the various phases via power supply terminals 12, one power supply terminal 12 per phase. The position of the power supply terminals 12 is shown schematically by hexagons referenced 12u, 12v and 12w.

FIG. 8 shows in particular a first layer c1 of connection frames associated with the connections of the coils of a first phase. The first layer c1 comprises four connection frames denoted 10a, 10b, 10c and 10d, as shown in FIG. 8. Each connection frame 10a, 10b, 10c, 10d is made in the form of a circular arc the ends of which connect two coils of the first phase. FIG. 7 also shows connection frames of other layers which will be described in more detail below.

Furthermore, in order to reduce the angular distance between the various power supply terminals 12u, 12v, 12w, the direction of power supply of one of the phases, in this case the phase associated with the power supply terminal 12v, is reversed relative to the other two phases. Reversal of the direction of power supply means that the power supply inputs and outputs are reversed. Alternatively, reversal of the direction of power supply may be achieved by reversing the direction of winding of the winding associated with this phase. Thus, instead of having three power supply terminals 12u, 12v, 12w arranged at 120° from one another as in FIG. 1, the power supply terminals 12u, 12v, 12w are distributed over a circular arc of 120°, two adjacent power supply terminals being separated by 60° as shown in FIG. 7.

FIG. 10 shows in particular a second layer c2 of connection frames 10 associated with the connections of the coils 5 of a second phase. The second layer c2 comprises four connection frames denoted 10e, 10f, 10g and 10h, as shown in FIG. 10. Each connection frame 10e, 10f, 10g, 10h is made in the form of a circular arc the ends of which connect two coils of the second phase.

FIG. 12 shows in particular a third layer c3 of connection frames 10 associated with a first portion of the connections of the coils of a third phase. The third layer comprises two connection frames denoted 10i and 10j, as shown in FIG. 12. Each connection frame 10i, 10j is made in the form of a circular arc the ends of which connect two coils of the third phase.

FIG. 13 shows a fourth layer c4 of connection frames 10, the connection frames 10u, 10v, 10w of which are associated with the power supply terminals 12u, 12v, 12w allowing the power supply of the phases, and a connection frame 10m associated with a first portion of the inter-phase connections associated with the star configuration allowing the paralleling of the first branches of each of the phases. Note also that the connection frames of this fourth layer c4 also appear in FIGS. 7, 9 and 11.

FIG. 14 shows in particular a fifth layer c5 of connection frames 10. The connection frames 10k and 10l of this fifth layer c5 are associated with a second portion of the connections of the coils 5 of the third phase and the connection frame 10n is associated with a second portion of the inter-phase connections associated with the star configuration allowing the paralleling of the second branches of each of the phases.

FIG. 15 shows a superposition of the five layers c1, c2, c3, c4, c5 of connection frames 10 presented in FIGS. 8, 10, 12, 13 and 14.

The various layers of connection frames 10 therefore have a generally annular shape formed by various circular arcs and may be superposed axially, the various layers being separated by electrically insulating interlayers to prevent any short circuit between the various connection frames 10. The assembly formed by the various layers may be arranged at the center of the stator body 3, that is to say at the center of the coils 5 arranged on the stator body 3, as shown in FIGS. 7, 9 and 11.

Thus, reversing the direction of power supply of one of the phases combined with the configuration of the connection frames presented in FIGS. 7 to 14 makes it possible to obtain a stator 1 the power supply terminals 12u, 12v, 12w of which are grouped together within an angular portion of 120°, without increasing the dimensions (radial or axial) of the stator 1.

In order to further reduce the angular distance between the power supply terminals 12u, 12v and 12w associated with the various phases, the connection frames 10u and 10w associated with the phases the power supply of which is not reversed may be extended toward the connection frame 10v associated with the phase having the power supply which is reversed, as shown in FIGS. 7, 9 and 11, and the power supply terminals 12u and 12w may be positioned at the end of the connection frames 10u and 10w located toward the connection frame 10v, as shown in FIG. 16. Such a configuration makes it possible to further reduce the angular distance between the various power supply terminals 12 and thus reduce the overall size of the stator 1.

The present invention also relates to an electric motor comprising a stator 1 as described above.

1. A stator (1) for a three-phase electric motor, comprising:
a plurality of coils (5) distributed circularly on a stator body (3),
a set of connection frames (10) arranged on various layers (c1, c2, c3, c4, c5) superposed axially and electrically insulated from one another, said connection frames (10) being configured to ensure the connections between the coils (5) of the various phases according to a predetermined electrical diagram and to ensure the power supply of the various phases via three power supply terminals (12u, 12v, 12w) associated with the respective phases,
characterized in that
the direction of power supply of one of the phases is reversed relative to the other two phases to limit the angular distance between the power supply terminals (12u, 12v, 12w) associated with the power supplies of the various phases.

2. The stator (1) as claimed in claim 1, wherein the connection frames (10u, 10v, 10w) associated with the power supply terminals (12u, 12v, 12w) allowing the power supply of the various phases are arranged on one and the same layer (c4) of connection frames (10).

3. The stator (1) as claimed in claim 2, wherein the connection frames (10u, 10w) associated with the power supply of the other two phases extend toward the connection frame (10v) associated with the power supply of the phase having the power supply which is reversed to receive the associated power supply terminal (12v) in order to reduce the angular distance between the power supply terminals (12u, 12v, 12w) associated with the power supply of the various phases.

4. The stator (1) as claimed in one of the preceding claims, wherein at least one of the layers (c1, c2, c3, c4, c5) of connection frames is used to achieve:
connections between the coils of various phases, and/or
connections between the coils of one phase and the power supply of one or more phases.

5. The stator (1) as claimed in one of the preceding claims, wherein the predetermined electrical diagram is a star configuration.

6. The stator (1) as claimed in one of the preceding claims, comprising eighteen coils (5), each phase comprising a first and a second branch of three coils (5) connected in series and wherein the connection frames (10) are distributed over five layers (c1, c2, c3, c4, c5).

7. The stator (1) as claimed in the preceding claim, wherein a first (c1) and a second (c2) layer of connection frames (10) respectively comprise the connection frames (10a, 10b, 10c, 10d, 10e, 10f, 10g, 10h) associated with the connections of the coils (5) of a first and a second phase, a third layer (c3) of connection frames (10) comprises the connection frames (10i, 10j) associated with a first portion of the connections of the coils (5) associated with the third phase, a fourth layer (c4) comprises the connection frames (10u, 10v, 10w) for power supply of the phases and a connection frame (10m) for paralleling the three first branches associated with the three phases and a fifth layer (c5) comprises the connection frames (10k, 10l) associated with the second portion of the connections of the coils (5) of the third phase and a connection frame (10n) for paralleling the three second branches associated with the three phases.

8. The stator (1) as claimed in one of the preceding claims, wherein the reversal of the direction of power supply of a phase is obtained by reversing the connections between the inputs and the outputs associated with the phase.

9. The stator (1) as claimed in one of the preceding claims, wherein the reversal of the direction of power supply of a phase is obtained by reversing the direction of winding of the phase.

10. An electric motor comprising a stator (1) as claimed in one of the preceding claims.
